(19) United States
(12) Patent Application Publication
(10) Pub. No.: US 2024/0242309 A1
(43) Pub. Date: Jul. 18, 2024

(54) SUPER RESOLUTION BASED ON SALIENCY

(71) Applicant: QUALCOMM Incorporated, San Diego, CA (US)

(72) Inventors: Zhongbo SHI, Shanghai (CN); Weixing WAN, Baoshan District, Shanghai (CN); Simiao WU, Shanghai (CN)

(21) Appl. No.: 18/558,611

(22) PCT Filed: Jul. 15, 2021
(86) PCT No.: PCT/CN2021/106384

§ 371 Date: Nov. 2, 2023

(51) Int. Cl. G06T 3/4053; G06T 3/4007; G06T 3/4046; G06T 7/11

(52) U.S. Cl. CPC G06T 3/4053; G06T 3/4007; G06T 3/4046; G06T 7/11; G06T 2207/10016; G06T 2207/20021; G06T 2207/20084; G06T 2207/20104

(57) ABSTRACT

Systems and techniques are described for image processing. For instance, an imaging system can obtain an input image with a first region and a second region, both at a first resolution. The imaging system can determine that the first region is more salient than the second region (e.g., based on a saliency map mapping saliency values to pixels of the input image). The imaging system can use a first process (e.g., using a trained network, such as of a machine learning super resolution system) to modify the first region to increase the first resolution to a second resolution. The imaging system can use a second process (e.g., based on an interpolation process) to modify the second region to increase the first resolution of the second region to the second resolution. The imaging system can generate and/or output an output image including the modified first region and the modified second region.

### FIELD

The present disclosure generally relates to image processing. For example, aspects of the present disclosure include systems and techniques for processing image data to generate super resolution images based on saliency.

### BACKGROUND

Super-resolution imaging refers to techniques that increase the resolution of an image. In some examples, super-resolution imaging techniques may include interpolation-based upscaling techniques, such as nearest neighbor interpolation or bilinear interpolation. However, traditional super-resolution imaging techniques based on interpolation generally produce images that are blurry and/or blocky, and therefore do not reproduce fine details accurately.

In imaging, the saliency of a pixel in an image refers to how unique the pixel is compared to other pixels of the image. In some cases, important visual elements of an image, such as depictions of people or animals, can have higher saliency values than background elements of an image.

### BRIEF SUMMARY

In some examples, systems and techniques are described for processing image data to generate super resolution images based on saliency. An imaging system obtains an input image, for example from an image sensor of the imaging system or from an external sender device. The input image has a first resolution, which may be a low resolution. The input image includes at least a first region and a second region, both of which have the first resolution. The imaging system can determine that the first region of the input image is more salient than the second region of the input image. For instance, the imaging system can generate a saliency map that maps a respective saliency value to each pixel of the input image, and that identifies the first region as more salient than the second region. In some examples, the imaging system can generate each saliency value for each pixel of the input image by applying a machine learning (ML) saliency mapping system to the input image. In some examples, the imaging system can partition the input image into multiple blocks, for example into a grid or lattice of blocks. The imaging system uses a ML super resolution system to modify the first region of the input image to increase the first resolution of the first region to a second resolution. The second resolution is greater than the first resolution. In examples where the imaging system partitions the input image into blocks, modifying the first region can include modifying each of a first subset of the blocks that corresponds to (e.g., includes at least a portion of) the first region from the first resolution to the second resolution. The imaging system uses interpolation to modify the second region of the input image to increase the first resolution of the second region to the second resolution. The interpolation can include, for example, nearest neighbor interpolation, bilinear interpolation, bicubic interpolation, other types of interpolation identified herein, or a combination thereof. In examples where the imaging system partitions the input image into blocks, modifying the second region can include modifying each of a second subset of the blocks that corresponds to (e.g., includes at least a portion of) the second region from the first resolution to the second resolution. The imaging system generates and/or outputs an output image including the modified first region and the modified second region. In examples where the imaging system partitions the input image into blocks, the imaging system can generate the output image at least in part by merging the plurality of blocks after modifying each of the plurality of blocks. The imaging system can apply a deblocking filter to the output image to reduce visual artifacts at the edges of the blocks.

In one example, an apparatus for processing image data is provided. The apparatus includes at least one memory and one or more processors (e.g., implemented in circuitry) coupled to the memory. The one or more processors are configured to and can: obtain an input image including a first region and a second region, the first region and the second region having a first resolution; determine that the first region of the input image is more salient than the second region of the input image; modify, using a first process, the first region of the input image to increase the first resolution of the first region to a second resolution; modify, using a second process, the second region of the input image to increase the first resolution of the second region to the second resolution, wherein the second process is different from the first process; and output an output image including the modified first region and the modified second region.

In another example, a method of processing image data is provided. The method includes: obtaining an input image including a first region and a second region, the first region and the second region having a first resolution; determining that the first region of the input image is more salient than the second region of the input image; modifying, using a first process, the first region of the input image to increase the first resolution of the first region to a second resolution; modifying, using a second process, the second region of the input image to increase the first resolution of the second region to the second resolution, wherein the second process is different from the first process; and outputting an output image including the modified first region and the modified second region.

In another example, a non-transitory computer-readable medium is provided that has stored thereon instructions that, when executed by one or more processors, cause the one or more processors to: obtain an input image including a first region and a second region, the first region and the second region having a first resolution; determine that the first region of the input image is more salient than the second region of the input image; modify, using a first process, the first region of the input image to increase the first resolution of the first region to a second resolution; modify, using a second process, the second region of the input image to increase the first resolution of the second region to the second resolution, wherein the second process is different from the first process; and output an output image including the modified first region and the modified second region

In another example, an apparatus for processing image data is provided. The apparatus includes: means for obtaining an input image including a first region and a second region, the first region and the second region having a first resolution; means for determining that the first region of the input image is more salient than the second region of the input image; means for modifying, using a first process, the first region of the input image to increase the first resolution of the first region to a second resolution; means for modifying, using a second process, the second region of the input image to increase the first resolution of the second region to the second resolution, wherein the second process is different from the first process; and means for outputting an output image including the modified first region and the modified second region.

In some aspects, the first region of the input image is modified using the first process based on determining that the first region is more salient than the second region.

In some aspects, wherein the first process is a super resolution process based on a trained network. For instance, to modify the first region of the input image using the first process, the methods, apparatuses, and computer-readable medium described above can include performing the super resolution process using a trained network. In some cases, the trained network includes one or more trained convolutional neural networks.

In some aspects, the second process is an interpolation process. For instance, to modify the second region of the input image using the second process, the methods, apparatuses, and computer-readable medium described above can include performing the interpolation process. In some cases, the interpolation process includes at least one of nearest neighbor interpolation, linear interpolation, bilinear interpolation, trilinear interpolation, cubic interpolation, bicubic interpolation, tricubic interpolation, spline interpolation, lanczos interpolation, sinc interpolation, Fourier-based interpolation, and edge-directed interpolation.

In some aspects, the methods, apparatuses, and computer-readable medium described above can include: determining the first region of the input image is more salient than the second region of the input image based on a saliency map. For instance, the saliency map can include one or more saliency values identifying the first region as more salient than the second region.

In some aspects, the methods, apparatuses, and computer-readable medium described above can include: generating the saliency map based on the input image at least in part by generating a respective saliency value of the one or more saliency values for each pixel of the input image.

In some aspects, a saliency value of the saliency map for a pixel of a plurality of pixels is based on a distance between the pixel and other pixels of the plurality of pixels.

In some aspects, to generate the saliency map, the methods, apparatuses, and computer-readable medium described above can include: applying an additional trained network to the input image. In some cases, the additional trained network includes one or more trained convolutional neural networks.

In some aspects, the methods, apparatuses, and computer-readable medium described above can include: partitioning the input image into a plurality of blocks. In some cases, each block of the plurality of blocks has a same shape and a same number of pixels as other blocks of the plurality of blocks. In some cases, the plurality of blocks include a first plurality of blocks and a second plurality of blocks, each block of the first plurality of blocks having a first shape and a first number of pixels, and each block of the second plurality of blocks having a second shape and a second number of pixels. In some aspects, the first plurality of blocks differs from the second plurality of blocks based on at least one of a number of pixels and shape.

In some aspects, to modify the first region of the input image, the methods, apparatuses, and computer-readable medium described above can include: using the first process to modify a first subset of the plurality of blocks corresponding to the first region of the input image from the first resolution to the second resolution.

In some aspects, to modify the second region of the input image, the methods, apparatuses, and computer-readable medium described above can include: using the second process to modify a second subset of the plurality of blocks corresponding to the second region of the input image.

In some aspects, to modify the first region of the input image and modify the second region of the input image, the methods, apparatuses, and computer-readable medium described above can include: modifying each of the plurality of blocks to increase the first resolution of each of the plurality of blocks to the second resolution.

In some aspects, the methods, apparatuses, and computer-readable medium described above can include: generating the output image at least in part by merging the plurality of blocks after modifying each of the plurality of blocks.

In some aspects, the methods, apparatuses, and computer-readable medium described above can include: modifying the output image at least in part by applying a deblocking filter to the output image.

In some aspects, the second resolution is based on a resolution of a display. In some cases, the methods, apparatuses, and computer-readable medium described above can include: displaying the output image on the display.

In some aspects, to output the output image, the methods, apparatuses, and computer-readable medium described above can include: causing the output image to be displayed on the display. For instance, the method can include displaying the output image on the display. In some cases, the apparatuses can include the display.

In some aspects, to obtain the input image, the methods, apparatuses, and computer-readable medium described above can include: receiving the input image from an image sensor configured to capture the input image. For instance, the apparatuses can include the image sensor.

In some aspects, the methods, apparatuses, and computer-readable medium described above can include: receiving at least one user input; and modifying at least one of the first region and the second region based on the at least one user input.

In some aspects, to obtain the input image, the methods, apparatuses, and computer-readable medium described above can include: receiving the input image from a sender device via a communication receiver. For instance, the apparatuses can include the communication receiver.

In some aspects, to output the output image, the methods, apparatuses, and computer-readable medium described above can include: transmitting the output image to a recipient device via a communication transmitter. For instance, the apparatuses can include the communication transmitter.

In some aspects, the output image is output as part of a sequence of video frames. In some cases, the output image is displayed in a preview stream (e.g., with the sequence of video frames).

In some aspects, one or more of the apparatuses described above is, is part of, and/or includes a mobile device (e.g., a mobile telephone or so-called “smart phone” or other mobile device), a wearable device, an extended reality device (e.g., a virtual reality (VR) device, an augmented reality (AR) device, or a mixed reality (MR) device), a camera, a personal computer, a laptop computer, a server computer, a vehicle or a computing device or component of a vehicle, or other device. In some aspects, the apparatus includes an image sensor or multiple image sensors (e.g., a camera or multiple cameras) for capturing one or more images. In some aspects, the apparatus additionally or alternatively includes a display for displaying one or more images, notifications, and/or other displayable data. In some aspects, the apparatuses described above can include one or more sensors (e.g., one or more inertial measurement units (IMUs), such as one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following drawing figures:

FIG. 1 is a block diagram illustrating an example architecture of an image capture and processing system, in accordance with some examples;

FIG. 2 is a block diagram illustrating an imaging system that generates of a saliency map based on an input image using a saliency mapper, in accordance with some examples;

FIG. 3 is a block diagram illustrating an imaging system that generates of a super-resolution output image from an input image based on increasing resolution of high saliency blocks using a machine learning (ML) based super-resolution engine and increasing resolution of low saliency blocks using an interpolation-based super-resolution engine, in accordance with some examples;

FIG. 4A is a conceptual diagram illustrating an example of an input image that includes a plurality of pixels labeled P0 through P63, in accordance with some examples;

FIG. 4B is a conceptual diagram illustrating an example of a saliency map mapping spatially varying saliency values corresponding to each of the pixels of the input image of FIG. 4A, in accordance with some examples;

FIG. 5 is a block diagram illustrating an example of a neural network that can be used by the imaging system to generate a saliency map and/or for the machine learning (ML) super-resolution engine, in accordance with some examples;

FIG. 6A is a block diagram illustrating an example of a neural network architecture of a trained neural network that can be used by the machine learning (ML) saliency mapper engine of the imaging system to generate the saliency map, in accordance with some examples;

FIG. 6B is a block diagram illustrating an example of a neural network architecture of a trained neural network that can be used by the machine learning (ML) super resolution engine of the imaging system to generate the output blocks, in accordance with some examples;

FIG. 7 is a conceptual diagram illustrating block lattice partitioning an image into large blocks, medium blocks, and small blocks, in accordance with some examples;

FIG. 8 is a flow diagram illustrating operations for processing image data, in accordance with some examples; and

FIG. 9 is a diagram illustrating an example of a computing system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

Super-resolution imaging refers to techniques that increase the resolution of an image. In some examples, super-resolution imaging techniques may include interpolation-based upscaling techniques, such as nearest neighbor interpolation, bilinear interpolation. An interpolation-based super-resolution technique may increase a resolution of an input image using interpolation to output an output image having a higher resolution than the input image. However, interpolation-based super-resolution imaging techniques generally produce images that are blurry and/or blocky, and therefore generally do not accurately reproduce fine details, such as faces, alphanumeric characters, textures, and/or intricate designs.

In some cases, super-resolution imaging can be performed using one or more trained machine learning (ML) models, such as one or more trained neural networks (NNs), one or more trained support vector machines (SVMs), one or more trained random forests, or a combination thereof. An ML-based super-resolution technique may input an input image into one or more ML models, which may output an output image having a higher resolution than the input image. However, fully ML-based super-resolution techniques may be too slow to use in certain applications, such as pass-through video in an extended reality (XR) context. XR may refer to virtual reality (VR), augmented reality (AR), mixed reality (MR), or a combination thereof. Furthermore, fully ML-based super-resolution techniques may be too power-intensive and/or processing-intensive for devices with limited battery power and/or limited computing resources, such as portable devices, to use consistently over an extended period of time.

In imaging, the saliency of a pixel in an image refers to how unique the pixel is compared to other pixels of the image. In some cases, important visual elements of an image, such as depictions of people or animals, can have higher saliency values than background elements of an image. In some cases, a saliency value for a given pixel of an image may be calculated as a sum of a set of differences between a pixel value for the pixel and each of a set of other pixel values for other pixels of the image. In some cases, a saliency value for a given pixel of an image may be determined using one or more trained machine learning (ML) models, such as one or more trained neural networks (NNs), one or more trained support vector machines (SVMs), one or more trained random forests, or a combination thereof. A saliency map may be generated using either of these methods, or a combination of these methods. A saliency map may map each pixel of an input image to a respective saliency value.

Systems and techniques are described for processing image data for an input image to generate and output a super resolution image based on saliency values in a saliency map of the input image. An imaging system obtains an input image, for example from an image sensor of the imaging system or from an external sender device. The input image has a first resolution, which may be a low resolution. The input image includes at least a first region and a second region, both of which have the first resolution. The imaging system can determine that the first region of the input image is more salient than the second region of the input image. For instance, the imaging system can generate a saliency map that maps a respective saliency value to each pixel of the input image, and that identifies the first region as more salient than the second region. The imaging system can generate each saliency value for each pixel of the input image by summing pixel distances between that pixel and other pixels of the input image. The imaging system can generate each saliency value for each pixel of the input image by applying a machine learning (ML) saliency mapping system to the input image. The ML saliency mapping system can include one or more trained neural networks (NNs), one or more trained convolutional neural networks (CNNs), one or more trained support vector machines (SVMs), one or more trained random forests, or a combination thereof. In some examples, the imaging system can partition the input image into multiple blocks, for example into a grid or lattice of blocks. In some examples, each block may have a same size and shape. In some examples, some blocks may be larger (e.g., include more pixels) than other blocks. In some examples, some blocks may have different shapes (e.g., include different ratios of height to length) than other blocks.

The imaging system uses a ML super resolution system to modify the first region of the input image to increase the first resolution of the first region to a second resolution. The second resolution is greater than the first resolution. The ML super resolution system can include one or more trained neural networks (NNs), one or more trained convolutional neural networks (CNNs), one or more trained support vector machines (SVMs), one or more trained random forests, or a combination thereof. In examples where the imaging system partitions the input image into blocks, modifying the first region can include modifying each of a first subset of the blocks that corresponds to (e.g., includes at least a portion of) the first region from the first resolution to the second resolution.

The imaging system uses interpolation to modify the second region of the input image to increase the first resolution of the second region to the second resolution. The interpolation can include, for example, nearest neighbor interpolation, linear interpolation, bilinear interpolation, trilinear interpolation, cubic interpolation, bicubic interpolation, tricubic interpolation, spline interpolation, lanczos interpolation, sinc interpolation, Fourier-based interpolation, edge-directed interpolation, or a combination thereof. In examples where the imaging system partitions the input image into blocks, modifying the second region can include modifying each of a second subset of the blocks that corresponds to (e.g., includes at least a portion of) the second region from the first resolution to the second resolution.

The imaging system generates and/or outputs an output image including the modified first region and the modified second region. In examples where the imaging system partitions the input image into blocks, the imaging system can generate the output image at least in part by merging the plurality of blocks after modifying each of the plurality of blocks. The imaging system can apply a deblocking filter to the output image to reduce visual artifacts at the edges of the blocks.

The imaging system provides technical improvements over fully interpolation-based super resolution techniques and systems by providing more accurate increases in resolution for features such as edges, patterns, textures, gradients, colors, fine details, or combinations thereof. For instance, the imaging system provides technical improvements over fully interpolation-based super resolution techniques and systems by providing more accurate increases in resolution for faces. The imaging system provides technical improvements over fully ML-based super resolution techniques and systems by preserving accurate increases in resolution high highly-salient regions (e.g., which may include fine details) while providing reduction in processing time, battery power consumption, processing power used, processing bandwidth used, or a combination thereof.

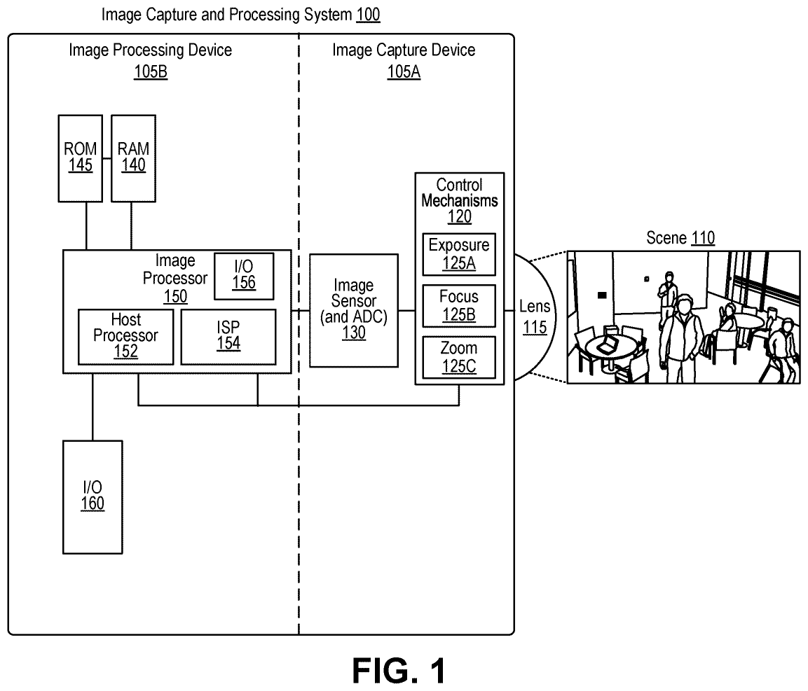

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cvan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 910 discussed with respect to the computing system 900. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface. an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140 and/or 920, read-only memory (ROM) 145 and/or 925, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 935, any other input devices 945, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the system 100 and one or more peripheral devices, over which the system 100 may receive data from the one or more peripheral device and/or transmit data to the one or more peripheral devices. The I/O 160 may include one or more wireless transceivers that enable a wireless connection between the system 100 and one or more peripheral devices, over which the system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

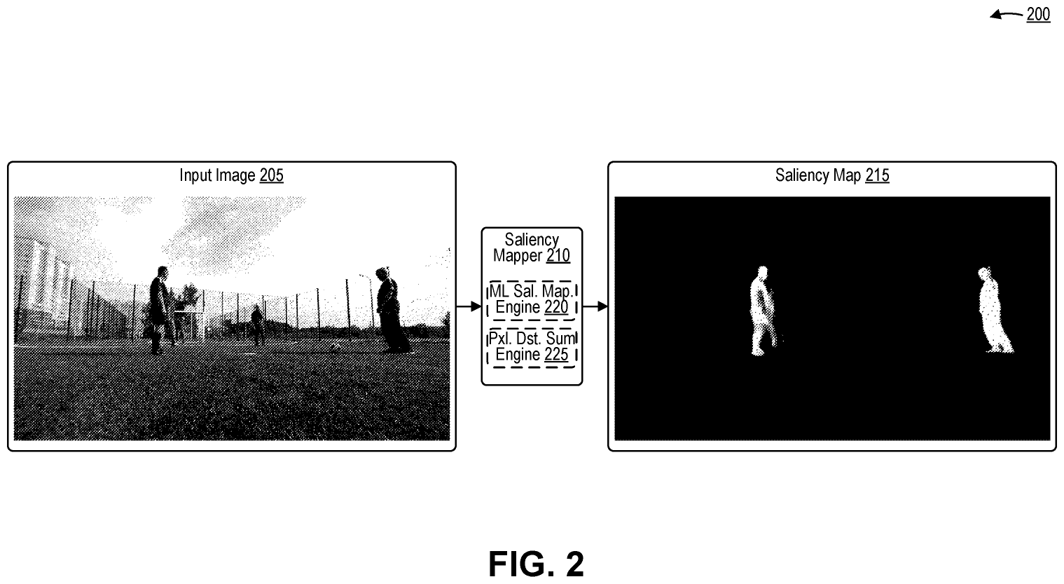

FIG. 2 is a block diagram illustrating an imaging system 200 that generates of a saliency map 215 based on an input image 205 using a saliency mapper 210. The input image 205 of FIG. 2 depicts five people playing soccer on a field surrounded by fences, with buildings in the background. Two of the five people are depicted in the foreground of the input image 205, in front of the other three people in the input image 205. The two people in the foreground of the input image 205 are larger and more prominent in the input image 205 than the other three people in the input image 205.

In imaging, a saliency value of a pixel in an image refers to how unique the pixel is compared to other pixels of the image. In some cases, important visual elements of an image, such as depictions of people or animals, can have higher saliency values than background elements of an image. A saliency map maps a saliency value to every pixel in an image. A saliency map can be depicted visually, for example by representing high saliency values (e.g., above a saliency value threshold) in whites and light grey shades in the saliency map and by representing low saliency values (e.g., below a saliency value threshold) in blacks and dark grey shades in the saliency map, or vice versa.

The saliency map 215 generated by the saliency mapper 210 identifies pixels of the input image 205 that have a high saliency value with white or light grey pixels in the saliency map 215. The saliency map 215 generated by the saliency mapper 210 identifies pixels of the input image 205 that have a low saliency value with black or dark grey pixels in the saliency map 215. The pixels in the input image 205 that depict the two people in the foreground of the input image 205, and a part of a third person who is depicted just behind one of the two people in the foreground of the input image 205, have high saliency values (e.g., above a saliency value threshold) according to the saliency map 215, and are therefore represented in whites and light grey shades in the saliency map 215. The remaining pixels of the input image 205 (e.g., depicting the grass, the fences, the buildings, and the remaining three people) have low saliency values (e.g., below a saliency value threshold) according to the saliency map 215, and are therefore represented in blacks and dark grey shades in the saliency map 215.

The saliency mapper 210 of the imaging system 200 can include a machine learning (ML) saliency mapper engine 220, a pixel distance sum engine 225, or both. The pixel distance sum engine 225 may calculate the respective saliency value for each pixel of the input image 205 to be (or to be based on) a sum of a plurality of pixel distances between that pixel and other pixels of the input image 205. For instance, a saliency value for a pixel k of the input image 205 can be determined by the pixel distance sum engine 225 using the formula saliency(k)=Σᵢ₌₁^{N}|Iₖ−Iᵢ|, where Iᵢ is a pixel value for a pixel i, Iₖ is a pixel value for the pixel k, and N is the total number of pixels in the input image 205. The pixel values Iᵢ and Iₖ can be, for instance numerical values lying in a range between 0 (black) and 255 (white). The pixel values Iᵢ and Iₖ can include multiple sets of numerical values each lying in a range between 0 and 255, for instance with a set each corresponding to different color channels (e.g., red, green, blue). The pixel values Iᵢ and Iₖ can be, for instance, hexadecimal color codes (e.g., HTML color codes) lying in a range between 000000 (black) and FFFFFF (white). The value of |Iₖ−Iᵢ| can represent a distance (e.g., Euclidean distance, Manhattan distance, Mahalanobis distance, Minkowski distance, or a combination thereof) between the set of one or more pixel values corresponding to the pixel k and the set of one or more pixel values corresponding to the pixel i. In some cases, the distance may be a distance in a multi-dimensional color space, for instance with different color channels (e.g., red, green, blue) changing along different axes in the multi-dimensional color space, with hue and luminosity changing along different axes in the multi-dimensional color space, or a combination thereof. In some examples, a multiplier m may be introduced into the saliency formula, making the formula saliency(k)=Σᵢ₌₁^{N}m·|Iₖ−Iᵢ|. In some examples, multiple pixels in the input image 205 may have identical pixel values, in which case a modified saliency formula may be used: saliency(k)=ΣFₙ·|Iₖ−Iₙ|, where Fₙ represents a frequency of how often the pixel value Iₙ appears in different pixels n in the input image 205. The saliency map 215 is an example of a saliency map that can be generated by pixel distance sum engine 225. The pixel distance sum engine 225 may be referred to as the pixel distance sum system.

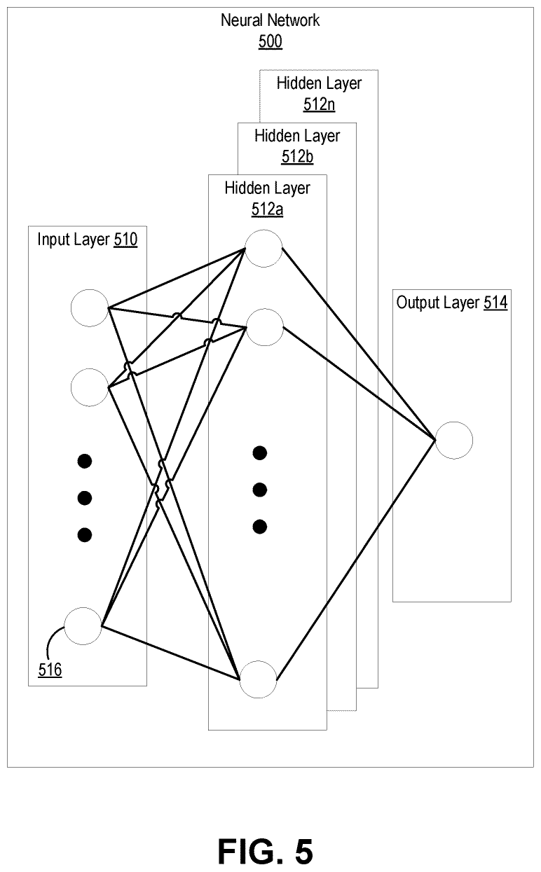

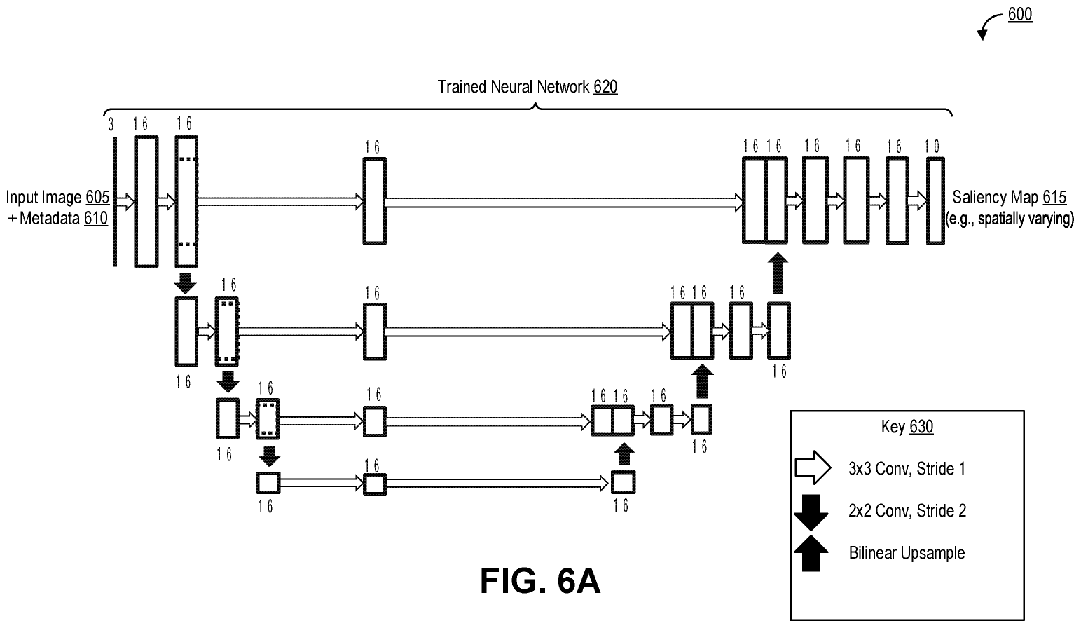

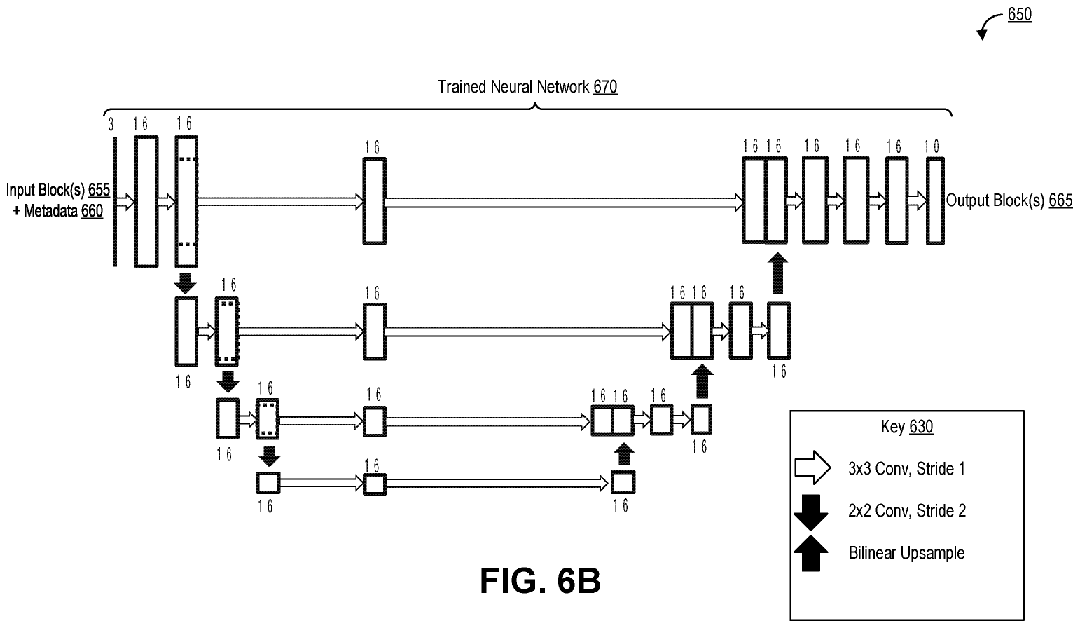

The saliency mapper 210 of the imaging system 200 can include a machine learning (ML) saliency mapper engine 220. The ML saliency mapper engine 220 can include one or more trained machine learning (ML) models, such as one or more trained neural networks (NNs), one or more trained support vector machines (SVMs), one or more trained random forests, or a combination thereof. The ML saliency mapper engine 220 can provide the input image 205, and/or metadata associated with the input image 205, to the one or more trained ML models as an input to the one or more trained ML models. The ML saliency mapper engine 220 can thus apply the one or more trained ML models to the input image 205 and/or to the metadata associated with the input image 205. The one or more trained ML models of the ML saliency mapper engine 220 may output the saliency map 215, or information that may be used by the saliency mapper 210 to generate the saliency map 210 (e.g., only positions of pixels having a saliency value above a threshold, or only positions of pixels having a saliency value below a threshold). In some examples, the one or more trained ML models of the ML saliency mapper engine 220 are trained using supervised learning, unsupervised learning, deep learning, or a combination thereof. In some examples, the one or more trained ML models of the ML saliency mapper engine 220 are trained using training data that includes images and corresponding saliency maps that were generated using the pixel distance sum engine 225, or a similar system. The neural network 500 of FIG. 5 may be an example of a neural network that is used as part of the ML saliency mapper engine 220. The neural network architecture 600 of FIG. 6A, with its trained neural network 620, may be an example of a neural network architecture that is used as part of the ML saliency mapper engine 220. The ML saliency mapper engine 220 may be referred to as the ML saliency mapper system, as a ML engine, as a ML system, or a combination thereof.

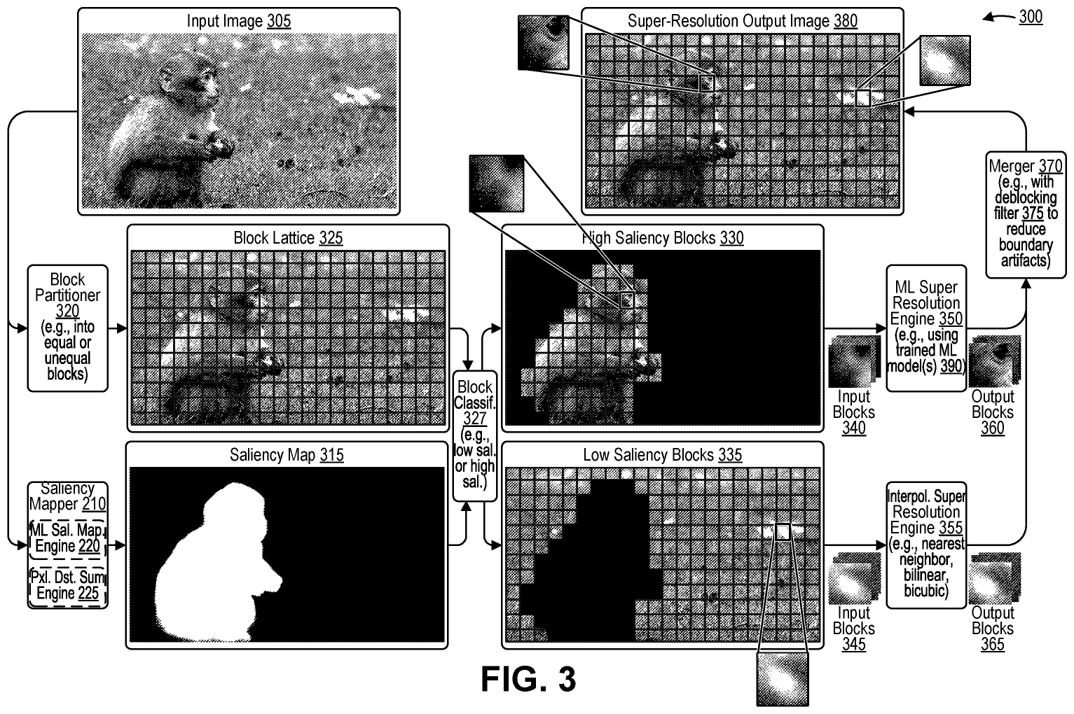

FIG. 3 is a block diagram illustrating an imaging system 300 that generates of a super-resolution output image 380 from an input image 305 based on increasing resolution of high saliency blocks 330 using a machine learning (ML) based super-resolution engine 350 and increasing resolution of low saliency blocks 335 using an interpolation-based super-resolution engine 355. The imaging system 300 obtains the input image 305, for example from an image sensor of the imaging system 300 or from an external sender device that the imaging system 300 is in communication with. The input image 305 illustrated in FIG. 3 depicts a monkey sitting on a field of grass. The input image 305 has a first resolution, which may be a low resolution.

The imaging system 300 includes the saliency mapper 210 of the imaging system 200. As in the imaging system 200, the saliency mapper 210 of the imaging system 300 can include the machine learning (ML) saliency mapper engine 220, the pixel distance sum engine 225, or both. The saliency mapper 210 of the imaging system 300 generates a saliency map 315 based on the input image 305. The saliency map 315 generated by the saliency mapper 210 identifies pixels of the input image 305 that have a high saliency value with white or light grey pixels in the saliency map 315. The saliency map 315 generated by the saliency mapper 210 identifies pixels of the input image 305 that have a low saliency value with black or dark grey pixels in the saliency map 315. The pixels of the input image 305 depicting the monkey in the foreground of the input image 305 have high saliency values (e.g., above a saliency value threshold) according to the saliency map 315, and are therefore represented in whites and light grey shades in the saliency map 315. The remaining pixels of the input image 305 (e.g., depicting the background behind the monkey) have low saliency values (e.g., below a saliency value threshold) according to the saliency map 315, and are therefore represented in blacks and dark grey shades in the saliency map 315. The saliency mapper 210 can generate the saliency map 315 from the input image 305 using the ML saliency mapper engine 220, the pixel distance sum engine 225, or a combination thereof.

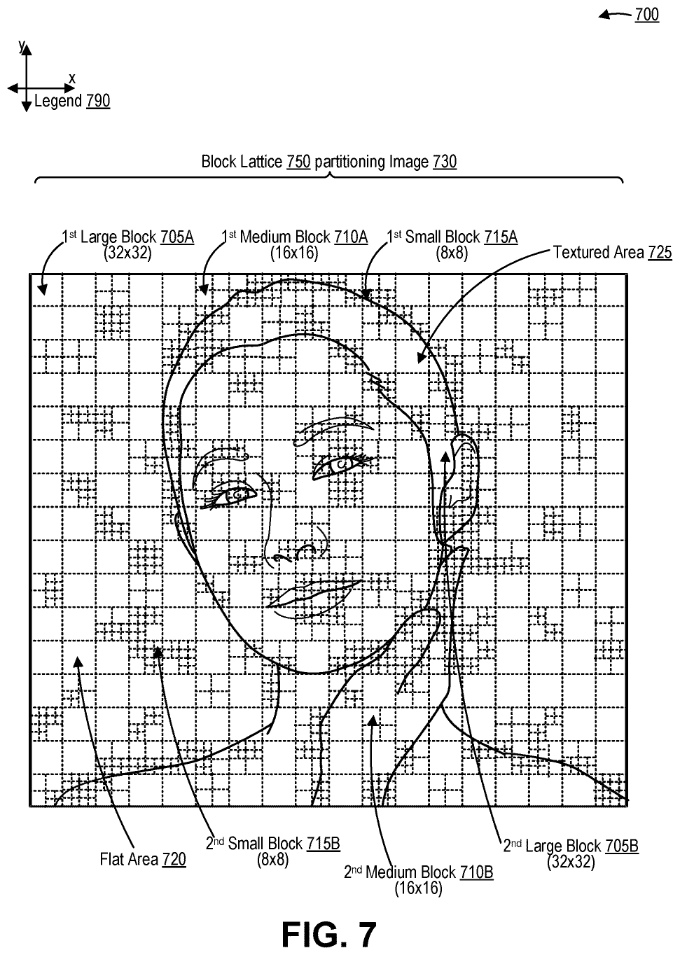

The imaging system 300 includes a block partitioner 320. The block partitioner 320 partitions the input image into multiple blocks arranged in a block lattice 325. The block lattice 325 may be referred to as a block grid. The blocks of the block lattice 325 of FIG. 3 are outlined in black over a copy of the input image 305. The block lattice 325 of FIG. 3 includes 12 blocks in height and 22 blocks in width, for a total of 264 blocks. The blocks in the block lattice 325 all share a same size (and thus a same number of pixels) and all share a same shape (square). In some examples, the block partitioner 320 can partition an image into blocks of different sizes (and thus different numbers of pixels), such as the three sizes of the block lattice 750 of FIG. 7. In some examples, the block partitioner 320 can partition an image into blocks of different shapes. For example, some blocks can be squares, while others are oblong rectangles (e.g., two or more adjacent square blocks may be joined together to form an oblong rectangle). Blocks may be quadrilaterals. Blocks need not be quadtrilaterals, and may for example be triangular, pentagonal, hexagonal, heptagonal, octagonal, nonagonal, decagonal, another polygonal shape, or a combination thereof. In some examples, blocks may include one or more curved sides. In some examples, the blocks are regular polyhedrons, and/or the block lattice 325 is a regular polyhedral lattice.

The imaging system 300 includes a block classifier 327 that classifies each of the blocks in the block lattice 325 as either high saliency blocks 330 or low saliency blocks 335 based on the saliency map 315. In the example illustrated in FIG. 3, the block classifier 327 classifies any block in the block lattice 325 that includes any portion of a high-saliency region as one of the high saliency blocks 330, even if the portion of the high-saliency region included in the block is small. In the example illustrated in FIG. 3, the block classifier 327 classifies any remaining block in the block lattice 325 (e.g., that includes no portion of a high-saliency region) as one of the low saliency blocks 335. Such a block classifier 327 errs on the side of over-inclusion of blocks into the set of high saliency blocks 330, and under-inclusion of blocks into the set of low saliency blocks 335. Classification of blocks in this manner increases the likelihood that blocks depicting more important elements in the image are enhanced using the ML super resolution engine 350 rather than the interpolation super resolution engine 355, and may result in a higher quality output image 380.

In some examples, the block classifier 327 can instead err on the side of over-inclusion of blocks into the set of low saliency blocks 335, and under-inclusion of blocks into the set of high saliency blocks 330. For example, the block classifier 327 can classify any block in the block lattice 325 that includes any portion of a low-saliency region as one of the low saliency blocks 335, even if the portion of the low-saliency region included in the block is small. The block classifier 327 can classify any remaining block in the block lattice 325 (e.g., that includes no portion of a low-saliency region) as one of the high saliency blocks 330. Classification of blocks in this manner can increase the likelihood that blocks are enhanced using the interpolation super resolution engine 355 rather than the ML super resolution engine 350, which can provide additional reductions in processing time, battery power consumption, processing power used, processing bandwidth used, or a combination thereof.

In some examples, the block classifier 327 can compare an amount of a high-saliency region that appears in a block to a threshold to determine whether to classify the block as one of the high saliency blocks 330 or as one of the low saliency blocks 335. For example, if an amount of a high-saliency region that appears in a block exceeds the threshold, the block classifier 327 can classify the block as one of the high saliency blocks 330. If an amount of a high-saliency region that appears in a block is less than the threshold, the block classifier 327 can classify the block as one of the low saliency blocks 335. The threshold may be 0%, 10%, 20%, 30%, 40%, 50%, 60%, 70%, 80%, 90%, 100%, or value in between any two of the previously listed values. The higher the threshold, the more the block classifier 327 errs on the side of over-inclusion of blocks into the set of high saliency blocks 330, and under-inclusion of blocks into the set of low saliency blocks 335. The lower the threshold, the more the block classifier 327 errs on the side of over-inclusion of blocks into the set of low saliency blocks 335, and under-inclusion of blocks into the set of high saliency blocks 330.

The set of high saliency blocks 330 is illustrated in FIG. 3 as a copy of the block lattice 325 in which high saliency blocks 330 are preserved as illustrated in the block lattice 325, while low saliency blocks 335 are blacked out. Thus, the set of high saliency blocks 330 is illustrated in FIG. 3 as including blocks depicting the monkey, with all other blocks (e.g., depicting the grass) blacked out as low saliency blocks 335. An example block depicting the monkey's eye is highlighted in a zoomed-in block showing that the monkey's eye appears blurry in the input image 305.

The set of low saliency blocks 335 is illustrated in FIG. 3 as a copy of the block lattice 325 in which low saliency blocks 335 are preserved as illustrated in the block lattice 325, while high saliency blocks 330 are blacked out. Thus, the set of low saliency blocks 330 is illustrated in FIG. 3 as including blocks depicting the grass, with all other blocks (e.g., depicting the monkey) blacked out as high saliency blocks 330. An example block depicting a bright patch of grass is highlighted in a zoomed-in block showing that the bright patch of grass appears blurry in the input image 305.

The high saliency blocks 330 are used as input blocks 340 for the ML super resolution engine 350, which performs ML-based super resolution imaging to increase the resolution of each of the input blocks 340 from a first resolution to a second resolution that is higher than the first resolution, thus producing generating the output blocks 360. The ML super resolution engine 350 can include one or more trained machine learning (ML) models 390, such as one or more trained neural networks (NNs), one or more trained support vector machines (SVMs), one or more trained random forests, or a combination thereof. The ML super resolution engine 350 can provide the input blocks 340, and/or metadata associated with the input blocks 340 and/or input image 305, to the one or more trained ML models 390 as an input to the one or more trained ML models 390. The ML super resolution engine 350 can thus apply the one or more trained ML models 390 to the input blocks 340, and/or metadata associated with the input blocks 340 and/or input image 305. The one or more trained ML models 390 of the ML super resolution engine 350 may output the output blocks 360. In some examples, the one or more trained ML models 390 of the ML super resolution engine 350 are trained using supervised learning, unsupervised learning, deep learning, or a combination thereof. In some examples, the one or more trained ML models 390 of the ML super resolution engine 350 are trained using training data that includes high-resolution images and corresponding downscaled (and thus low-resolution) versions of the high-resolution images. The neural network 500 of FIG. 5 may be an example of a neural network that is used as part of the ML super resolution engine 350, for example as one of the one or more trained ML models 390. The neural network architecture 650 of FIG. 6B, with its trained neural network 670, may be an example of a neural network architecture that is used as part of the ML super resolution engine 350, for example as one of the one or more trained ML models 390. The ML super resolution engine 350 may be referred to as the ML super resolution system, as a ML engine, as a ML system, or a combination thereof. Examples of the input blocks 340 and output blocks 360 are illustrated in FIG. 3, with details such as the eyelids around the monkey's eye appearing noticeably sharper and clearer in the output blocks 360 than in the input blocks 340, where such details are blurry.

The low saliency blocks 335 are used as input blocks 345 for the interpolation super resolution engine 355, which performs interpolation-based super resolution imaging to increase the resolution of each of the input blocks 345 from a first resolution to a second resolution that is higher than the first resolution, thus producing generating the output blocks 365. The interpolation super resolution engine 355 can increase the resolution of each of the input blocks 345 from the first resolution to the second resolution using one or more interpolation techniques, such as nearest neighbor interpolation, linear interpolation, bilinear interpolation, trilinear interpolation, cubic interpolation, bicubic interpolation, tricubic interpolation, spline interpolation, lanczos interpolation, sinc interpolation, Fourier-based interpolation, edge-directed interpolation, or a combination thereof. The interpolation super resolution engine 355 may be referred to as the interpolation super resolution system, as an interpolation engine, as an interpolation system, or a combination thereof. Examples of the input blocks 345 and output blocks 365 are illustrated in FIG. 3, with details in the grass having a similar level of detail, sharpness, and clarity in both the input blocks 345 and the output blocks 365.

The imaging system 300 includes a merger 370 that merges the output blocks 360 produced by the ML super resolution engine 350 (generated based on the high saliency blocks 330) with the output blocks 365 produced by the interpolation super resolution engine 355 (generated based on the low saliency blocks 335). The merger 370 positions each of the output blocks 360 into the block lattice 325 where a corresponding one of the input blocks 340 originally was, as part of the set of high saliency blocks 330. The merger 370 positions each of the output blocks 365 into the block lattice 325 where a corresponding one of the input blocks 345 originally was, as part of the set of low saliency blocks 335. The merger 370 thus generates the super-resolution output image 380 by merging the output blocks 360 and the output blocks 365, arranged as the corresponding input blocks 340 and input blocks 345 were in the block lattice 325. In some examples, the merger 370 can include a deblocking filter 375, which the merger 370 may apply to the super resolution output image 380 to reduce visual artifacts at the edges of the blocks in the super resolution output image 380. The deblocking filter 375 can use the input image 305 as a reference frame. In some examples, the deblocking filter 375 can apply blurring, such as Gaussian blurring, along the edges of the blocks where blocking artifacts appear in the super resolution output image 380 that do not appear in the input image 305. In some examples, the deblocking filter 375 can import image data from the input image 305 (e.g., with interpolation super resolution imaging applied by the interpolation super resolution engine 355) along the edges of the blocks where blocking artifacts appear in the super resolution output image 380 that do not appear in the input image 305. Blocking artifacts can include, for example, noticeable differences (e.g., greater than a threshold) in color, hue, saturation, luminosity, or a combination thereof.

In some examples, the deblocking filter 375 can be applied using a ML deblocking engine (not pictured), which may include one or more trained ML models, such as one or more trained NNs, one or more trained SVMs, one or more trained random forests, or a combination thereof. The ML deblocking engine may use the merged super-resolution output image 380, without the deblocking filter 375 applied yet, as an input to the one or more trained ML models of the ML deblocking engine. In some examples, the input image 305 and/or metadata associated with the input image may also be input(s) to the one or more trained ML models of the ML deblocking engine. The one or more trained ML models of the ML deblocking engine can be applied to the merged super-resolution output image 380, without the deblocking filter 375 applied yet, to generate a super-resolution output image 380 with the deblocking filter 375 applied. The neural network 500 of FIG. 5 may be an example of a neural network that is used as part of the ML deblocking engine. The ML deblocking engine may use a neural network architecture similar to the neural network architecture 600, the neural network architecture 650, or a combination thereof.

The super-resolution output image 380 is illustrated with a lattice of black lines overlaid representing the boundaries of the output blocks 360 and the boundaries of the output blocks 365. An example block depicting the monkey's eye in the super-resolution output image 380 is highlighted in a zoomed-in block showing that the monkey's eye appears sharp, clear, and detailed in the super-resolution output image 380. An example block depicting a bright patch of grass in the super-resolution output image 380 is highlighted in a zoomed-in block showing that the bright patch of grass appears to have a similar level of detail, sharpness, and clarity in the super-resolution output image 380 as in the input image 305.

In some examples, the resolution of the output blocks 360/365, and of the super-resolution output image 380, can be selected based on a resolution of a display. For instance, the resolution of the output blocks 360/365, and of the super-resolution output image 380, can be selected so that the width of the display has the same number of pixels as the width of the super-resolution output image 380, so that the height of the display has the same number of pixels as the height of the super-resolution output image 380, or both. The imaging system can output the super-resolution output image 380 at least in part by displaying the super-resolution output image 380 on the display. The imaging system can output the super-resolution output image 380 at least in part by transmitting the super-resolution output image 380 to a recipient device using a communication transmitter. The recipient device can then display the super-resolution output image 380 on a display of the recipient device.

In some examples, the imaging system 300 does not include, or does not use, the block partitioner 320. Instead, the imaging system 300 can extract a high-saliency region of the input image 305 based on the saliency map 315 (e.g., the high-saliency region including only those pixels of the input image 305 whose saliency values exceed a saliency value threshold as indicated in the saliency map 315), and feed this high-saliency region into the ML super resolution engine 350 to produce a super resolution version of the high-saliency region. The imaging system 300 can extract a low-saliency region of the input image 305 based on the saliency map 315 (e.g., the low-saliency region including only those pixels of the input image 305 whose saliency values are less than the saliency value threshold as indicated in the saliency map 315), and feed this low-saliency region into the interpolation super resolution engine 355 to produce a super resolution version of the low-saliency region. In some examples, the high-saliency region may be extracted as an image with alpha transparency corresponding to the low-saliency regions of the input image 305. In some examples, the low-saliency region may be extracted as an image with alpha transparency corresponding to the high-saliency regions of the input image 305. In some examples, the super resolution version of the high saliency region and the super resolution version of the low resolution region may retain this transparency. In such examples, the merger 370 may overlay the super resolution version of the high saliency region over the super resolution version of the low resolution region, or vice versa, to generate the super-resolution output image 380. In some examples, a specific color (e.g., a color not otherwise used in the input image 305) may be selected to be used as a substitute for such transparent region(s), for instance for devices or image codecs that do not include an alpha transparency channel, or to save storage space by not encoding an alpha transparency channel.

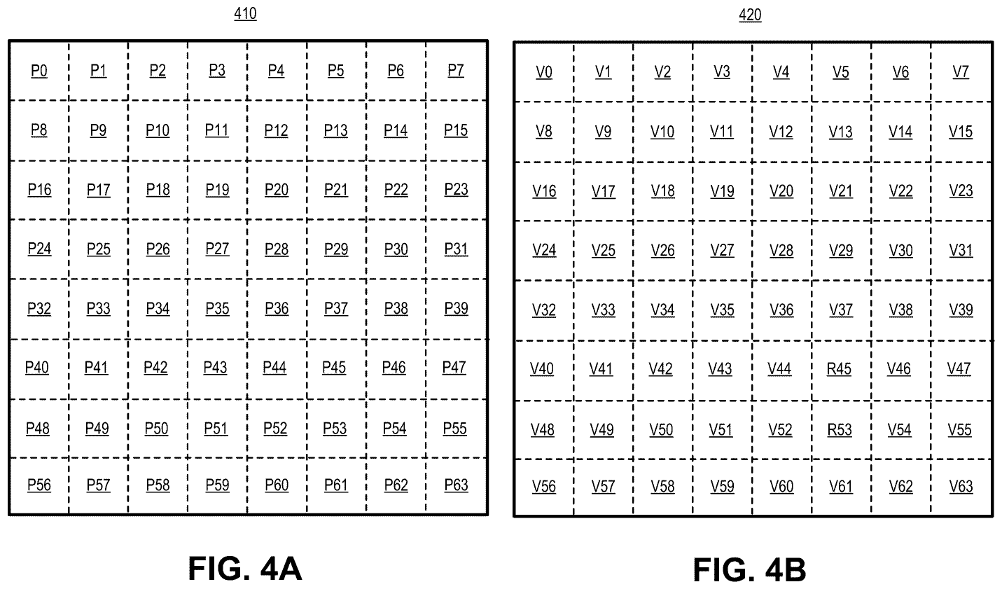

FIG. 4A is a conceptual diagram illustrating an example of an input image 410 that includes a plurality of pixels labeled P0 through P63. The input image 410 is 9 pixels wide and 9 pixels in height. The pixels are numbered sequentially from P0 to P63 from left to right within each row, starting from the top row and counting up toward the bottom row.

FIG. 4B is a conceptual diagram illustrating an example of a saliency map 420 mapping spatially varying saliency values corresponding to each of the pixels of the input image 410 of FIG. 4A. The spatially varying saliency values include a plurality of values labeled V0 through V63. The spatially varying saliency values are illustrated as a tuning map 420 that is 9 cells (pixels) wide and 9 cells (pixels) in height. The cells are numbered sequentially from V0 to V63 from left to right within each row, starting from the top row and counting up toward the bottom row.

Each saliency values in each cells of the saliency map 420 corresponds to a pixel in the input image 410. For example, the value V0 in the tuning map 420 corresponds to the pixel P0 in the input image 410. A value in the saliency map 420 is used to indicate a saliency value of its corresponding pixel in the input image 410 as determined using the saliency mapper 210. The saliency values of pixels control whether that pixel is in a high saliency region (e.g., depicted as white or light grey in the saliency maps 215 and 315) or a low saliency region (e.g., depicted as black or dark grey in the saliency maps 215 and 315) in the saliency map 420. The saliency values of pixels, together with a block partitioning into a block lattice (e.g., block lattice 325), control whether that pixel is in a high saliency block (e.g., high saliency blocks 330) or a low saliency block (e.g., low saliency blocks 335).

FIG. 5 is a block diagram illustrating an example of a neural network 500 that can be used by the imaging system (e.g., imaging system 200 or imaging system 300) to generate a saliency map (e.g., saliency map 215, saliency map 315, saliency map 420, or saliency map 615) and/or for the machine learning (ML) super-resolution engine 350. The neural network 500 can include any type of deep network, such as a convolutional neural network (CNN), an autoencoder, a deep belief net (DBN), a Recurrent Neural Network (RNN), a Generative Adversarial Networks (GAN), and/or other type of neural network. The neural network 500 may be, for example, one of the one or more trained ML models 390 of the ML super-resolution engine 350. The neural network 500 may be, for example, the trained neural network 620. The neural network 500 may be, for example, the trained neural network 670.

An input layer 510 of the neural network 500 includes input data. The input data of the input layer 510 can include data representing the pixels of an input image frame. In an illustrative example, the input data of the input layer 510 can include data representing the pixels of image data (e.g., the input image 205, the input image 305, the input image 410, the input image 605, the input blocks 340, the input blocks 655, or a combination thereof) and/or metadata corresponding to the image data (e.g., metadata 610, metadata 660, or a combination thereof). In one illustrative example, the input data of the input layer 510 can include the input image 205, the input image 305, the input image 410, the input image 605, and/or the metadata 610. In another illustrative example, the input data of the input layer 510 can include the input blocks 340, the input blocks 655, and/or the metadata 660. The images can include image data from an image sensor including raw pixel data (including a single color per pixel based, for example, on a Bayer filter) or processed pixel values (e.g., RGB pixels of an RGB image). The neural network 500 includes multiple hidden layers 512a, 512b, through 512n. The hidden layers 512a, 512b, through 512n include “n” number of hidden layers, where “n” is an integer greater than or equal to one. The number of hidden layers can be made to include as many layers as needed for the given application. The neural network 500 further includes an output layer 514 that provides an output resulting from the processing performed by the hidden layers 512a, 512b, through 512n. In some examples, the output layer 514 can provide a saliency map, such as the saliency map 215, the saliency map 315, the saliency map 420, and/or the saliency map 615. In some examples, the output layer 514 can provide output blocks, such as the output blocks 360 and/or the output blocks 665.

The neural network 500 is a multi-layer neural network of interconnected filters. Each filter can be trained to learn a feature representative of the input data. Information associated with the filters is shared among the different layers and each layer retains information as information is processed. In some cases, the neural network 500 can include a feed-forward network, in which case there are no feedback connections where outputs of the network are fed back into itself. In some cases, the network 500 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 510 can activate a set of nodes in the first hidden layer 512a. For example, as shown, each of the input nodes of the input layer 510 can be connected to each of the nodes of the first hidden layer 512a. The nodes of a hidden layer can transform the information of each input node by applying activation functions (e.g., filters) to the information. The information derived from the transformation can then be passed to and can activate the nodes of the next hidden layer 512b, which can perform their own designated functions. Example functions include convolutional functions, downscaling, upscaling, data transformation, and/or any other suitable functions. The output of the hidden layer 512b can then activate nodes of the next hidden layer, and so on. The output of the last hidden layer 512n can activate one or more nodes of the output layer 514, which provides a processed output image. In some cases, while nodes (e.g., node 516) in the neural network 500 are shown as having multiple output lines, a node has a single output and all lines shown as being output from a node represent the same output value.

In some cases, each node or interconnection between nodes can have a weight that is a set of parameters derived from the training of the neural network 500. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 510 using the different hidden layers 512a, 512b, through 512n in order to provide the output through the output layer 514.

FIG. 6A is a block diagram illustrating an example of a neural network architecture 600 of a trained neural network 620 that can be used by the machine learning (ML) saliency mapper engine 220 of an imaging system (e.g., imaging system 200 or imaging system 300) to generate a saliency map 615. Examples of the saliency map 615 include the saliency map 215, the saliency map 315, and/or the saliency map 420. For instance, the imaging system may be the imaging system 200, in which case the saliency map may be the saliency map 215. The imaging system may be the imaging system 300, in which case the saliency map may be the saliency map 315.

The trained neural network 620 may be an example of one of the one or more trained ML models of the ML saliency mapper engine 220. The neural network architecture 600 receives, as its input, an input image 605 and metadata 610. The input image 605 may include raw image data (e.g., having separate color components) or processed (e.g., demosaicked) image data. Examples of the input image 605 include the input image 205 or the input image 305. The metadata 610 may include information about the input image 605, such as the image capture settings used to capture the input image 605, date and/or time of capture of the input image 605, the location of capture of the input image 605, the orientation (e.g., pitch, yaw, and/or roll) of capture of the input image 605, or a combination thereof.

The trained neural network 620 outputs saliency values corresponding to pixels of the input image 605, for instance in the form of one or more saliency maps 615 that map each pixel of the input image 605 to a respective saliency value. Examples of the one or more saliency maps 615 include the saliency map 215, the saliency map 315, and/or the saliency map 420. The trained neural network 620 can output the one or more saliency maps 615 as images, for example with different luminosities representing different saliency values (e.g., as illustrated in the saliency map 215 and the saliency map 315). The trained neural network 620 can output the one or more saliency maps 615 as sets of individual saliency values, which may be arranged in a list, matrix, a grid, a table, a database, another data structure, or a combination thereof.

A key 630 identifies different NN operations performed by the trained NN 620 to generate the saliency map(s) 615 based on the input image 605 and/or the metadata 610. For instance, convolutions with 3×3 filters and a stride of 1 are indicated by a thick white arrow outlined in black and pointing to the right. Convolutions with 2×2 filters and a stride of 2 are indicated by a thick black arrow pointing downward. Upsampling (e.g., bilinear upsampling) is indicated by a thick black arrow pointing upward.

FIG. 6B is a block diagram illustrating an example of a neural network architecture 650 of a trained neural network 670 that can be used by the machine learning (ML) super resolution engine 350 of the imaging system 300 to generate the output blocks 665. Examples of the output blocks 665 include the output blocks 360 generated by the ML super resolution engine 350.

The trained neural network 670 may be an example of one of the one or more trained ML models 390 of the ML super resolution engine 350. The neural network architecture 650 receives, as its input, one or more input block(s) 665 and/or metadata 660. Examples of the one or more input block(s) 665 include the input blocks 340 of FIG. 3. The input block(s) 665 may include raw image data (e.g., having separate color components) or processed (e.g., demosaicked) image data. The metadata 660 may include information about the input image from which the input block(s) 665 are extracted (e.g., the input image 605), such as the image capture settings used to capture the input image, date and/or time of capture of the input image, the location of capture of the input image, the orientation (e.g., pitch, yaw, and/or roll) of capture of the input image, or a combination thereof. The metadata 660 may include information about where, in the input image, the input block(s) 665 were extracted from (e.g., coordinates along the two-dimensional plane of the input image).

The trained neural network 670 outputs one or more output block(s) 665 that represent enhanced variants of the input block(s) 655, with the resolution of each of the input block(s) 655 increased from a first (low) resolution to a second (high) resolution. The second resolution is greater than the first resolution. Examples of the one or more output block(s) 665 include the output block(s) 360.

The key 630 of FIG. 6A is also reproduced in FIG. 6B, and identifies different NN operations performed by the trained NN 670 to generate the output block(s) 665 based on the input block(s) 655 and/or the metadata 660.

FIG. 7 is a conceptual diagram 700 illustrating block lattice 750 partitioning an image 730 into large blocks, medium blocks, and small blocks. The image 730 depicts a woman in the foreground in front of a flat white background. The image 730 can be a video frame of a video. A legend 790 illustrates a horizontal X axis and a vertical Y axis that is perpendicular to the horizontal X axis. The image 730 is illustrated on a plane spanning the X axis and the Y axis.

Examples of the large blocks include large blocks 705A-705B. Examples of the medium blocks include medium blocks 710A-710B. Examples of the small blocks include small blocks 715A and 715B. These blocks may be squares of varying sizes, such as 128 square pixels (128×128 pixels), 64 square pixels (64×64 pixels), 32 square pixels (32×32 pixels), 16 square pixels (16×16 pixels), 8 square pixels (8×8 pixels), or 4 square pixels (4×4 pixels). In the example illustrated in FIG. 7, the large blocks are 32×32 pixels, the medium blocks are 16×16 pixels, and the small blocks are 8×8 pixels.

The exemplary block lattice 750 of the image 730 illustrated in FIG. 7 produces blocks of various sizes. For example, a first large block 705A with a size of 32 square pixels is illustrated in the very top-left of the image. The first large block 705A is at the very top of the image 730 along the Y axis, and the very left of the image 730 along the X axis. The first large block 705A is positioned within a flat area 720 depicting the background behind the woman depicted in the image 730. The first large block 705A is positioned relatively far away from the depiction of the woman in the image 730. A first medium block 710A with a size of 16 square pixels is illustrated near the top of the image 730 along the Y axis, to the left of the horizontal center along the X axis of the image 730. The first medium block 710A is positioned within a flat area 720 depicting the background behind the woman depicted in the image 730. The first medium block 710A is close to the depiction of the woman in the image 730, as the next block to the right of the first medium block 710A along the X axis depicts an edge between the background and a portion of the woman's hair. A first small block 715A with a size of 8 square pixels is illustrated near the top of the image 730 along the Y axis, to the right of the horizontal center along the X axis of the image 730. The first small block 715A depicts an edge between the background and a portion of the woman's hair. The woman's hair is a textured area 725.

In some cases, smaller block sizes (e.g., 16×16, 8×8, 4×4) are best used in areas of the image 730 that are more complex, such as those depicting edges of objects or textured content. Hence, the first small block 715A depicts an edge between a flat area 720 (the background) and a textured area 725 (the woman's hair). The first medium block 710A is positioned near a similar edge. On the other hand, larger block sizes (e.g., 128×128, 64×64, 32×32, 16×16) are in some cases best used in areas of an image or video frame that are relatively simple and/or flat, and/or that lack complexities such as textures and/or edges. Hence, the first large block 705A depicts a flat area 720 (the background). The first medium block 710A likewise depicts a flat area 720 (the background), despite being positioned near an edge between the flat area 720 (the background) and a textured area 725 (the woman's hair).

In some cases, a larger block size (e.g., 128×128, 64×64, 32×32, 16×16) may be optimal in an area of the image 730 that is complex, such as the textured area 725. For example, the second large block 705B depicts both the textured area 725 (the woman's hair) and several edges, including an edge between the textured area 725 (the woman's hair) and the woman's face, an edge textured area 725 (the woman's hair) and the woman's ear, and several edges depicting different parts of the woman's ear. Likewise, in some cases, a smaller block size (e.g., 16×16, 8×8, 4×4) may be optimal in an area of the image 730 that is flat and simple and lacks complexities. For example, the second small block 705B depicts the flat area 720 (the background) and is positioned relatively far away from the depiction of the woman in the image 730. The second medium block 710B depicts a relatively flat and simple area of skin on the hand of the woman in the image 730.

In some cases, the block partitioner 320 may generate the block lattice 750 based on factors related to image compression, video compression, or a combination thereof. For example, the image 730 may be an image undergoing compression or a frame of a video undergoing compression, in which case block partitioning to generate the block lattice 750 may be performed as part of these compression procedures, and the same block lattice 750 can be used by the imaging system as the block lattice 325 of the imaging system 300. For example, the block partitioner 320 may generate the block lattice 750 based on rate-distortion optimization (RDO) or an estimate of RDO. In compression contexts, blocks in the block lattice 750 may be referred to as coding units (CUs), coding tree units (CTUs), largest coding units (LCUs), or combinations thereof.

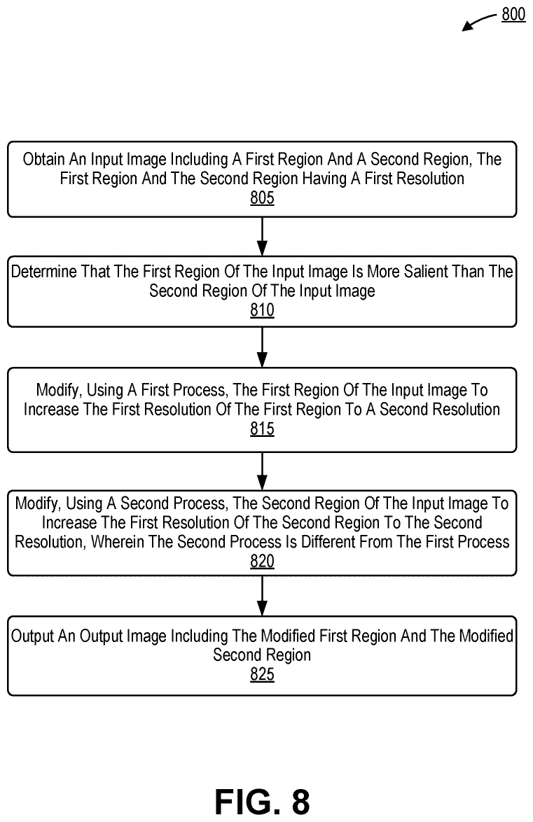

FIG. 8 is a flow diagram illustrating an example of a process 800 for processing image data. The operations of the process 800 may be performed by an imaging system. In some examples, the imaging system that performs the operations of the process 800 can be the imaging system 300. In some examples, the imaging system that performs the operations of the process 800 can include, for example, the image capture and processing system 100, the image capture device 105A, the image processing device 105B, the image processor 150, the ISP 154, the host processor 152, the imaging system 200, the imaging system 300, the neural network 500, the neural network architecture 600, the trained neural network 620, the neural network architecture 650, the trained neural network 670, a computing system 900, or a combination thereof.

At operation 805, the process 800 includes obtaining (e.g., by the imaging system) an input image including a first region and a second region. The first region and the second region having a first resolution. One illustrative example of the input image includes the input image 305 of FIG. 3. In some examples, to obtain the input image, the process 800 can include receiving the input image from an image sensor (e.g., of an apparatus or computing device, such as the apparatus or computing device performing the process 800) configured to capture the input image. In some examples, to obtain the input image, the process 800 can include receiving the input image from a sender device via a communication receiver (e.g., of an apparatus or computing device, such as the apparatus or computing device performing the process 800).

At operation 810, the process 800 includes determining (e.g., by the imaging system) that the first region of the input image is more salient than the second region of the input image. In some examples, the process 800 can include determining (e.g., by the imaging system) the first region of the input image is more salient than the second region of the input image based on a saliency map. For instance, the saliency map can include one or more saliency values identifying the first region as more salient than the second region.

In some aspects, the process 800 can include generating (e.g., by the imaging system) the saliency map based on the input image at least in part by generating a respective saliency value of the one or more saliency values for each pixel of the input image. In one example, the saliency mapper 210 of FIG. 2 and FIG. 3 can be used to generate the saliency map. In some cases, a saliency value of the saliency map for a pixel of a plurality of pixels (of the saliency map) is based on a distance between the pixel and other pixels of the plurality of pixels. In one illustrative example, as noted above, the saliency mapper 210 of the imaging system 200 can include a pixel distance sum engine 225, which can calculate the respective saliency value for each pixel of the input image 205 to be (or to be based on) a sum of a plurality of pixel distances between that pixel and other pixels of the input image 205. Various illustrative examples are provided herein with respect to FIG. 2 and FIG. 3. In some aspects, to generate the saliency map, the process 800 can apply an additional trained network (e.g., one or more trained convolutional neural networks) to the input image. In one illustrative example, the additional trained network can include the ML saliency mapper engine 220 of FIG. 2 and FIG. 3, which can include one or more trained ML models, such as one or more trained neural networks (NNs), one or more trained support vector machines (SVMs), one or more trained random forests, any combination thereof, and/or other trained ML model.

At operation 815, the process 800 includes modifying (e.g., by the imaging system), using a first process, the first region of the input image to increase the first resolution of the first region to a second resolution. In some cases, the first region of the input image is modified using the first process based on determining that the first region is more salient than the second region. In some examples, the first process is a super resolution process based on a trained network. For instance, to modify the first region of the input image using the first process, the process 800 (e.g., using the imaging system) can perform a super resolution process using a trained network. In some cases, the trained network includes one or more trained convolutional neural networks. In one illustrative example, the trained network can include the ML based super-resolution engine 350 of FIG. 3.

At operation 820, the process 800 includes modifying (e.g., by the imaging system), using a second process, the second region of the input image to increase the first resolution of the second region to the second resolution. The second process is different from the first process. In some examples, the second process is an interpolation process that is different from the first process (which can be performed using a trained network in some cases, as noted above). For instance, to modify the second region of the input image using the second process, the process 800 can include performing the interpolation process. In one illustrative example, the interpolation process can be performed by the interpolation-based super-resolution engine 355 of FIG. 3. In some cases, the interpolation process includes a nearest neighbor interpolation, linear interpolation, bilinear interpolation, trilinear interpolation, cubic interpolation, bicubic interpolation, tricubic interpolation, spline interpolation, lanczos interpolation, sinc interpolation, Fourier-based interpolation, edge-directed interpolation, any combination thereof, and/or other interpolation process.

In some aspects, the process 800 can include partitioning the input image into a plurality of blocks. In one illustrative example, the block partitioner 320 of FIG. 3 can partition the input image 305 into a plurality of blocks, as shown in FIG. 3. In some cases, each block of the plurality of blocks has a same shape and a same number of pixels as other blocks of the plurality of blocks. In some cases, the plurality of blocks include a first plurality of blocks and a second plurality of blocks, where each block of the first plurality of blocks has a first shape and a first number of pixels, and where each block of the second plurality of blocks has a second shape and a second number of pixels. In some examples, the first plurality of blocks differs from the second plurality of blocks based on a number of pixels and/or based on shape. In one example, in some cases, some blocks may be larger (e.g., include more pixels) than other blocks. In another example, some blocks may have different shapes (e.g., include different ratios of height to length) than other blocks. In another example, some blocks may be larger (e.g., include more pixels) and may have different shapes (e.g., include different ratios of height to length) than other blocks.

In some cases, to modify the first region of the input image, the process 800 can include using the first process (e.g., a trained network, such as the ML based super-resolution engine 350 of FIG. 3) to modify a first subset of the plurality of blocks corresponding to the first region of the input image from the first resolution to the second resolution. Additionally or alternatively, in some cases, to modify the second region of the input image, the process 800 can include using the second process (e.g., the interpolation process, such as using the interpolation-based super-resolution engine 355 of FIG. 3) to modify a second subset of the plurality of blocks corresponding to the second region of the input image. Additionally or alternatively, in some examples, to modify the first region of the input image and modify the second region of the input image, the process 800 can include modifying each block (e.g., all blocks) of the plurality of blocks to increase the first resolution of each of the plurality of blocks to the second resolution.

At operation 825, the process 800 includes outputting (e.g., by the imaging system) an output image including the modified first region and the modified second region. As noted above, in some cases, the process 800 can partition the input image into a plurality of blocks. In such cases, the process 800 can include generating the output image at least in part by merging the plurality of blocks after modifying each of the plurality of blocks. In some aspects, the process 800 can include modifying the output image at least in part by applying a deblocking filter to the output image.

In some implementations, the super resolution systems and techniques described herein can be performed in response to receiving a user input. For instance, a user can provide a user input (e.g., a touch input, a gesture input, a voice input, pressing of a physical or virtual button, etc.) to select a super resolution setting that causes the process 800 and/or other operation or process described herein to be performed. In one illustrative example, the process 800 can be performed based on the user input. For instance, the process 800 can include receiving at least one user input (e.g., via an input device, such as a touchscreen, image sensor, microphone, physical or virtual button, etc.). Based on the at least one user input, the process 800 can include one or more of determining that the first region of the input image is more salient than the second region of the input image, modifying at least one of the first region and the second region, and/or output the output image.

In some examples, the second resolution is based on a resolution of a display of an apparatus or computing device (e.g., the apparatus or computing device performing the process 800). In some cases, the process 800 can include displaying the output image on the display (or causing the output image to be displayed on the display). In some aspects, to output the output image, the process 800 can include causing the output image to be displayed on the display. In some aspects, to output the output image, the process 800 can include transmitting the output image to a recipient device via a communication transmitter of an apparatus or computing device (e.g., the apparatus or computing device performing the process 800). In some examples, the output image is output as part of a sequence of video frames. In some cases, the output image is displayed in a preview stream (e.g., with the sequence of video frames).

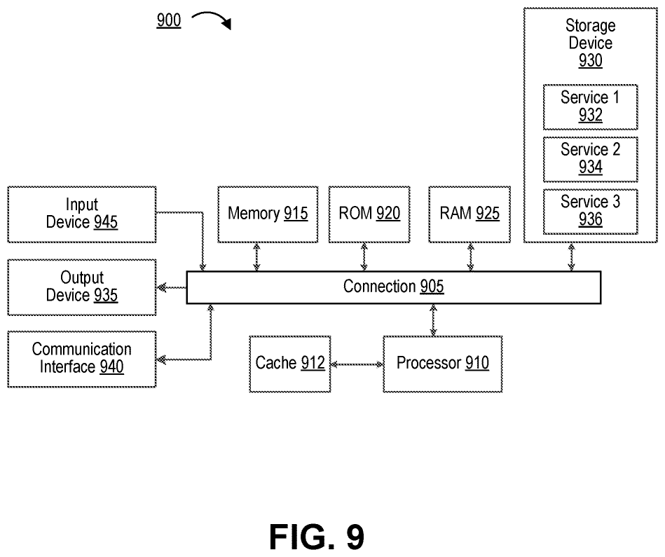

In some aspects, the imaging system can include means for obtaining the input image including the first region and the second region. In some examples, the means for obtaining can include the saliency mapper 210 of FIG. 2 and/or FIG. 3, the block partitioner 320 of FIG. 3, the communication interface 940 of FIG. 9, the processor 910 of FIG. 9, and/or other component that is configured to obtain an input image. In some aspects, the imaging system can include means for determining that the first region of the input image is more salient than the second region of the input image. In some examples, the means for determining can include the saliency mapper 210 of FIG. 2 and/or FIG. 3, the block classifier 327 of FIG. 3, the processor 910 of FIG. 9, and/or other component that is configured to obtain an input image.

In some aspects, the imaging system can include means for modifying, using the first process, the first region of the input image to increase the first resolution of the first region to the second resolution. In some examples, the means for modifying the first region can include the ML based super-resolution engine 350 of FIG. 3, the processor 910 of FIG. 9, and/or other component that is configured to obtain an input image. In some aspects, the imaging system can include means for modifying, using a second process, the second region of the input image to increase the first resolution of the second region to the second resolution. In some examples, the means for modifying the second region can include the interpolation-based super-resolution engine 355 of FIG. 3, the processor 910 of FIG. 9, and/or other component that is configured to obtain an input image.

In some aspects, the imaging system can include means for outputting an output image including the modified first region and the modified second region. In some examples, the means for outputting the output image can include the merger 370 of FIG. 3, the processor 910 of FIG. 9, the communication interface 940 of FIG. 9, the output device 935 of FIG. 9, a display, and/or other component that is configured to obtain an input image.

In some examples, the processes described herein (e.g., process 800 and/or other processes described herein) may be performed by a computing device or apparatus. In some examples, the operations of the process 800 can be performed by the imaging system 200 and/or the imaging system 300. In some examples, the operations of the process 800 can be performed by a computing device with the computing system 900 shown in FIG. 9. For instance, a computing device with the computing system 900 shown in FIG. 9 can include at least some of the components of the imaging system 200 and/or the imaging system 300, and/or can implement the operations of the process 800 of FIG. 8.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, a vehicle (e.g., an autonomous vehicle or human-driven vehicle) or computing device of a vehicle, a robotic device, a television, and/or any other computing device with the resource capabilities to perform the processes described herein, including the operations of process 800. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The operations of the process 800 are illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the operations of the process 800 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 900 includes at least one processing unit (CPU or processor) 910 and connection 905 that couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some embodiments, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment mav be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:
Aspect 1: An apparatus for processing image data, the apparatus comprising: a memory; and one or more processors coupled to the memory, the one or more processors configured to: obtain an input image including a first region and a second region, the first region and the second region having a first resolution; determine that the first region of the input image is more salient than the second region of the input image; modify, using a first process, the first region of the input image to increase the first resolution of the first region to a second resolution; modify, using a second process, the second region of the input image to increase the first resolution of the second region to the second resolution, wherein the second process is different from the first process; and output an output image including the modified first region and the modified second region.
Aspect 2: The apparatus of aspect 1, wherein, to modify the first region of the input image using the first process, the one or more processors are configured to perform a super resolution process using a trained network.
Aspect 3: The apparatus of aspect 2, wherein the trained network includes one or more trained convolutional neural networks.
Aspect 4: The apparatus of any one of aspects 1 to 3, wherein, to modify the second region of the input image using the second process, the one or more processors are configured to perform an interpolation process.
Aspect 5: The apparatus of aspect 4, wherein the interpolation process includes at least one of nearest neighbor interpolation, linear interpolation, bilinear interpolation, trilinear interpolation, cubic interpolation, bicubic interpolation, tricubic interpolation, spline interpolation, lanczos interpolation, sinc interpolation, Fourier-based interpolation, and edge-directed interpolation.
Aspect 6: The apparatus of any one of aspects 1 to 5, wherein the one or more processors are configured to determine the first region of the input image is more salient than the second region of the input image based on a saliency map, the saliency map including one or more saliency values identifying the first region as more salient than the second region.
Aspect 7: The apparatus of aspect 6, wherein the one or more processors are configured to: generate the saliency map based on the input image at least in part by generating a respective saliency value of the one or more saliency values for each pixel of the input image.
Aspect 8: The apparatus of any one of aspects 6 or 7, wherein a saliency value of the saliency map for a pixel of a plurality of pixels is based on a distance between the pixel and other pixels of the plurality of pixels.
Aspect 9: The apparatus of any one of aspect 6 to 8, wherein, to generate the saliency map, the one or more processors are configured to: apply an additional trained network to the input image.
Aspect 10: The apparatus of aspect 9, wherein the additional trained network includes one or more trained convolutional neural networks.
Aspect 11: The apparatus of any one of aspects 1 to 10, wherein the one or more processors are configured to: partition the input image into a plurality of blocks.
Aspect 12: The apparatus of aspect 11, wherein each block of the plurality of blocks has a same shape and a same number of pixels as other blocks of the plurality of blocks.
Aspect 13: The apparatus of aspect 11, wherein the plurality of blocks include a first plurality of blocks and a second plurality of blocks, each block of the first plurality of blocks having a first shape and a first number of pixels, each block of the second plurality of blocks having a second shape and a second number of pixels, wherein the first plurality of blocks differs from the second plurality of blocks based on at least one of a number of pixels and shape.
Aspect 14: The apparatus of any one of aspects 11 to 13, wherein, to modify the first region of the input image, the one or more processors are configured to use the first process to modify a first subset of the plurality of blocks corresponding to the first region of the input image from the first resolution to the second resolution.
Aspect 15: The apparatus of any one of aspects 11 to 14, wherein, to modify the second region of the input image, the one or more processors are configured to use the second process to modify a second subset of the plurality of blocks corresponding to the second region of the input image.
Aspect 16: The apparatus of any one of aspects 11 to 15, wherein, to modify the first region of the input image and modify the second region of the input image, the one or more processors are configured to: modify each of the plurality of blocks to increase the first resolution of each of the plurality of blocks to the second resolution.
Aspect 17: The apparatus of any one of aspects 11 to 16, wherein the one or more processors are configured to: generate the output image at least in part by merging the plurality of blocks after modifying each of the plurality of blocks.
Aspect 18: The apparatus of any one of aspects 1 to 17, wherein the one or more processors are configured to: modify the output image at least in part by applying a deblocking filter to the output image.
Aspect 19: The apparatus of any one of aspects 1 to 18, wherein the second resolution is based on a resolution of a display, and wherein the one or more processors are configured to display the output image on the display.
Aspect 20: The apparatus of any one of aspects 1 to 19, further comprising: a display, wherein to output the output image, the one or more processors are configured to cause the output image to be displayed on the display.
Aspect 21: The apparatus of any one of aspects 1 to 20, further comprising: an image sensor configured to capture the input image, wherein to obtain the input image, the one or more processors are configured to receive the input image from the image sensor.
Aspect 22: The apparatus of any one of aspects 1 to 21, wherein the one or more processors are configured to: receive at least one user input; and modify at least one of the first region and the second region based on the at least one user input.
Aspect 23: The apparatus of any one of aspects 1 to 22, further comprising: a communication receiver, wherein to obtain the input image, the one or more processors are configured to receive the input image from a sender device via the communication receiver.
Aspect 24: The apparatus of any one of aspects 1 to 23, further comprising: a communication transmitter, wherein to output the output image, the one or more processors are configured to transmit the output image to a recipient device via the communication transmitter.
Aspect 25: The apparatus of any one of aspects 1 to 24, wherein the output image is output as part of a sequence of video frames.
Aspect 26: The apparatus of aspect 25, wherein the output image is displayed in a preview stream.
Aspect 27: The apparatus of any one of aspects 1 to 26, wherein the first region of the input image is modified using the first process based on determining that the first region is more salient than the second region.
Aspect 28: A method of processing image data, comprising: obtaining an input image including a first region and a second region, the first region and the second region having a first resolution; determining that the first region of the input image is more salient than the second region of the input image; modifying, using a first process, the first region of the input image to increase the first resolution of the first region to a second resolution; modifying, using a second process, the second region of the input image to increase the first resolution of the second region to the second resolution, wherein the second process is different from the first process; and outputting an output image including the modified first region and the modified second region.
Aspect 29: The method of aspect 28, wherein modifying the first region of the input image using the first process includes performing a super resolution process using a trained network.
Aspect 30: The method of aspect 29, wherein the trained network includes one or more trained convolutional neural networks.
Aspect 31: The method of any one of aspects 28 to 30, wherein modifying the second region of the input image using the second process includes performing an interpolation process.
Aspect 32: The method of aspect 31, wherein the interpolation process includes at least one of nearest neighbor interpolation, linear interpolation, bilinear interpolation, trilinear interpolation, cubic interpolation, bicubic interpolation, tricubic interpolation, spline interpolation, lanczos interpolation, sinc interpolation, Fourier-based interpolation, and edge-directed interpolation.
Aspect 33: The method of any one of aspects 28 to 32, further comprising determining the first region of the input image is more salient than the second region of the input image based on a saliency map, the saliency map including one or more saliency values identifying the first region as more salient than the second region.
Aspect 34: The method of aspect 33, further comprising: generating the saliency map based on the input image at least in part by generating a respective saliency value of the one or more saliency values for each pixel of the input image.
Aspect 35: The method of any one of aspects 33 or 34, wherein a saliency value of the saliency map for a pixel of a plurality of pixels is based on a distance between the pixel and other pixels of the plurality of pixels.
Aspect 36: The method of any one of aspect 33 to 35, wherein generating the saliency map includes applying an additional trained network to the input image.
Aspect 37: The method of aspect 36, wherein the additional trained network includes one or more trained convolutional neural networks.
Aspect 38: The method of any one of aspects 28 to 37, further comprising: partitioning the input image into a plurality of blocks.
Aspect 39: The method of aspect 38, wherein each block of the plurality of blocks has a same shape and a same number of pixels as other blocks of the plurality of blocks.
Aspect 40: The method of aspect 38, wherein the plurality of blocks include a first plurality of blocks and a second plurality of blocks, each block of the first plurality of blocks having a first shape and a first number of pixels, each block of the second plurality of blocks having a second shape and a second number of pixels, wherein the first plurality of blocks differs from the second plurality of blocks based on at least one of a number of pixels and shape.
Aspect 41: The method of any one of aspects 38 to 40, wherein modifying the first region of the input image includes using the first process to modify a first subset of the plurality of blocks corresponding to the first region of the input image from the first resolution to the second resolution.
Aspect 42: The method of any one of aspects 38 to 41, wherein modifying the second region of the input image includes using the second process to modify a second subset of the plurality of blocks corresponding to the second region of the input image.
Aspect 43: The method of any one of aspects 38 to 42, wherein modifying the first region of the input image and modifying the second region of the input image includes modifying each of the plurality of blocks to increase the first resolution of each of the plurality of blocks to the second resolution.
Aspect 44: The method of any one of aspects 38 to 43, further comprising: generating the output image at least in part by merging the plurality of blocks after modifying each of the plurality of blocks.
Aspect 45: The method of any one of aspects 28 to 44, further comprising: modifying the output image at least in part by applying a deblocking filter to the output image.
Aspect 46: The method of any one of aspects 28 to 45, wherein the second resolution is based on a resolution of a display, and further comprising displaying the output image on the display.
Aspect 47: The method of any one of aspects 28 to 46, wherein outputting the output image includes causing the output image to be displayed on a display.
Aspect 48: The method of any one of aspects 28 to 47, wherein obtaining the input image includes receiving the input image from an image sensor.
Aspect 49: The method of any one of aspects 28 to 48, further comprising receiving at least one user input; and modifying at least one of the first region and the second region based on the at least one user input.
Aspect 50: The method of any one of aspects 28 to 49, wherein obtaining the input image includes receiving the input image from a sender device via a communication receiver.
Aspect 51: The method of any one of aspects 28 to 50, wherein outputting the output image includes transmitting the output image to a recipient device via the communication transmitter.
Aspect 52: The method of any one of aspects 28 to 51, wherein the output image is output as part of a sequence of video frames.
Aspect 53: The method of aspect 52, wherein the output image is displayed in a preview stream.
Aspect 54: The method of any one of aspects 28 to 53, wherein the first region of the input image is modified using the first process based on determining that the first region is more salient than the second region.
Aspect 55. A computer-readable storage medium storing instructions that, when executed by one or more processors, cause the one or more processors to perform operations according to any of Aspects 1 to 54.
Aspect 56. An apparatus comprising means for performing operations according to any of Aspects 1 to 54.

1. An apparatus for processing image data, the apparatus comprising:
a memory; and
one or more processors coupled to the memory, the one or more processors configured to:
obtain an input image including a first region and a second region, the first region and the second region having a first resolution;
determine that the first region of the input image is more salient than the second region of the input image;
modify, using a first process, the first region of the input image to increase the first resolution of the first region to a second resolution;
modify, using a second process, the second region of the input image to increase the first resolution of the second region to the second resolution, wherein the second process is different from the first process; and
output an output image including the modified first region and the modified second region.

2. The apparatus of claim 1, wherein, to modify the first region of the input image using the first process, the one or more processors are configured to perform a super resolution process using a trained network.

3. The apparatus of claim 2, wherein the trained network includes one or more trained convolutional neural networks.

4. The apparatus of claim 1, wherein the second process is an interpolation process.

5. The apparatus of claim 4, wherein the interpolation process includes at least one of nearest neighbor interpolation, linear interpolation, bilinear interpolation, trilinear interpolation, cubic interpolation, bicubic interpolation, tricubic interpolation, spline interpolation, lanczos interpolation, sinc interpolation, Fourier-based interpolation, and edge-directed interpolation.

6. The apparatus of claim 1, wherein the one or more processors are configured to determine the first region of the input image is more salient than the second region of the input image based on a saliency map, the saliency map including one or more saliency values identifying the first region as more salient than the second region.

7. The apparatus of claim 6, wherein the one or more processors are configured to:
generate the saliency map based on the input image at least in part by generating a respective saliency value of the one or more saliency values for each pixel of the input image.

8. The apparatus of claim 6, wherein a saliency value of the saliency map for a pixel of a plurality of pixels is based on a distance between the pixel and other pixels of the plurality of pixels.

9. The apparatus of claim 6, wherein, to generate the saliency map, the one or more processors are configured to:
apply an additional trained network to the input image.

10. The apparatus of claim 9, wherein the additional trained network includes one or more trained convolutional neural networks.

11. The apparatus of claim 1, wherein the one or more processors are configured to:
partition the input image into a plurality of blocks.

12. The apparatus of claim 11, wherein each block of the plurality of blocks has a same shape and a same number of pixels as other blocks of the plurality of blocks.

13. The apparatus of claim 11, wherein the plurality of blocks include a first plurality of blocks and a second plurality of blocks, each block of the first plurality of blocks having a first shape and a first number of pixels, each block of the second plurality of blocks having a second shape and a second number of pixels, wherein the first plurality of blocks differs from the second plurality of blocks based on at least one of a number of pixels and shape.

14. The apparatus of claim 11, wherein, to modify the first region of the input image, the one or more processors are configured to use the first process to modify a first subset of the plurality of blocks corresponding to the first region of the input image from the first resolution to the second resolution.

15. The apparatus of claim 11, wherein, to modify the second region of the input image, the one or more processors are configured to use the second process to modify a second subset of the plurality of blocks corresponding to the second region of the input image.

16. The apparatus of claim 11, wherein, to modify the first region of the input image and modify the second region of the input image, the one or more processors are configured to:
modify each of the plurality of blocks to increase the first resolution of each of the plurality of blocks to the second resolution.

17. The apparatus of claim 1, wherein the second resolution is based on a resolution of a display, and wherein the one or more processors are configured to display the output image on the display.

18. The apparatus of claim 1, further comprising:
a display, wherein to output the output image, the one or more processors are configured to cause the output image to be displayed on the display.

19. The apparatus of claim 1, further comprising:
an image sensor configured to capture the input image, wherein to obtain the input image, the one or more processors are configured to receive the input image from the image sensor.

20. The apparatus of claim 1, wherein the one or more processors are configured to:
receive at least one user input; and
modify at least one of the first region and the second region based on the at least one user input.

21. The apparatus of claim 1, wherein the output image is output as part of a sequence of video frames.

22. The apparatus of claim 21, wherein the output image is displayed in a preview stream.

23. A method of processing image data, comprising:
obtaining an input image including a first region and a second region, the first region and the second region having a first resolution;
determining that the first region of the input image is more salient than the second region of the input image;
modifying, using a first process, the first region of the input image to increase the first resolution of the first region to a second resolution;
modifying, using a second process, the second region of the input image to increase the first resolution of the second region to the second resolution, wherein the second process is different from the first process; and
outputting an output image including the modified first region and the modified second region.

24. The method of claim 23, wherein modifying the first region of the input image using the first process includes performing a super resolution process using a trained network.

25. The method of claim 23, wherein modifying the second region of the input image using the second process includes performing an interpolation process.

26. The method of claim 23, wherein the first region of the input image is determined to be more salient than the second region of the input image based on a saliency map, the saliency map including one or more saliency values identifying the first region as more salient than the second region.

27. The method of claim 26, further comprising:
generating the saliency map based on the input image at least in part by generating a respective saliency value of the one or more saliency values for each pixel of the input image.

28. The method of claim 23, further comprising:
partitioning the input image into a plurality of blocks, wherein each block of the plurality of blocks has a same shape and a same number of pixels as other blocks of the plurality of blocks.

29. The method of claim 23, further comprising:
partitioning the input image into a first plurality of blocks and a second plurality of blocks, each block of the first plurality of blocks having a first shape and a first number of pixels, each block of the second plurality of blocks having a second shape and a second number of pixels, wherein the first plurality of blocks differs from the second plurality of blocks based on at least one of a number of pixels and shape.

30. The method of claim 23, further comprising:
partitioning the input image into a plurality of blocks;
wherein modifying the first region of the input image includes using the first process to modify a first subset of the plurality of blocks corresponding to the first region of the input image from the first resolution to the second resolution; and
wherein modifying the second region of the input image includes using the second process to modify a second subset of the plurality of blocks corresponding to the second region of the input image.
